(19) United States
(12) Patent Application Publication
(10) Pub. No.: US 2011/0117537 A1
(43) Pub. Date: May 19, 2011

(54) USAGE ESTIMATION DEVICE

(76) Inventor: Junichi Funada, Tokyo (JP)

(21) Appl. No.: 13/054,671

(22) PCT Filed: Jun. 5, 2009
(86) PCT No.: PCT/JP2009/002550

§ 371 Date: Jan. 18, 2011

(30) Foreign Application Priority Data
Jul. 24, 2008 (JP) 2008-190656

(51) Int. Cl. G09B 25/00

(52) U.S. Cl. 434/365

(57) ABSTRACT

Predicting a transition of usage of a user on a terminal device. A trajectory made by dividing operation history information of a user on the terminal device by time, calculating a group of feature amount representing the usage for each piece of the operation history information in each division section, and connecting points corresponding to the group of feature amount on a space based on the feature amount is referred to as a usage trajectory. A processing device 110 compares the usage trajectory of each reference user calculated from the operation history information of a plurality of reference users with the usage trajectory calculated from the operation history information of a user to be analyzed, and estimates future usage of the user to be analyzed from the usage trajectory of the reference user that is similar to the usage trajectory of the user to be analyzed.

### TECHNICAL FIELD

The present invention relates to a device for estimating future usage features of a user on a terminal device, and a device for recommending information according to the estimated features of usage to the user.

### BACKGROUND ART

Terminal devices such as a mobile phone, a personal computer, and a home appliance, are more functionalized each year, and equipped with many functions from functions that can be readily used by beginners to functions that can be mastered only by certain level experts. Therefore, there are some products that in an operation manual, functions according to a user's level of proficiency are explained as a basic edition, a development edition, etc. However, since the user needed to evaluate the user's own level of proficiency, it has been difficult to objectively and correctly evaluate the level of proficiency. Therefore, the phenomenon tends to occur such as trying the function that cannot be mastered and cognitive load is increased instead, or an error is generated to reduce the convenience of the user.

On the other hand, patent literature 1 discloses a technique to evaluate the level of proficiency of the user from operation history of the user on the terminal device and control a display method of the device for the purpose of improving user convenience. In the technique disclosed in patent literature 1, the current level of proficiency of the user is evaluated based on usage history information (the number of power-on of the device, the time when the user performed key input operation and its history, etc.) of the terminal device (for example a mobile phone) from the first purchase to present, and simplifies the display according to the user's level of proficiency.

### CITATION LIST

### Patent Literature 1

Japanese Unexamined Patent Application Publication No. 2006-202320

### SUMMARY OF INVENTION

### Technical Problem

According to the technique disclosed in patent literature 1 that evaluates user's level of proficiency from the operation history of the user on the terminal device, it is possible to automatically evaluate the user's level of proficiency based on the objective fact which is the operation history. Therefore, by applying this technique to a technique to recommend the function according to the level of proficiency to the user, it is possible to realize service such as recommending the function according to the current level of proficiency to the user among various functions included in the terminal device. However, it is not possible to realize the service to recommend the function according to the near future level of proficiency and not the current one.

Although it is also relatively effective to recommend the function according to the user's current level of proficiency, in order to promote further improvement of the user's level of proficiency, it may be desirable to recommend the function according to the near future level of proficiency and not the current one. For that purpose, the technique that can objectively evaluate the near future level of proficiency and not the current level of proficiency is required.

Generally in a multifunction device such as a mobile phone and a personal computer, as shown in FIG. 14, even if everyone belongs to the same beginner user group at first, a difference is generated in the direction of proficiency depending on a preference, habit, and intended use, and users are branched into many different user groups with different usage features such that a certain user becomes a member of a user group skilled in e-mail related operations, and another user becomes a member of a user group skilled in word processor related operations. Further, even among multiple users who transit to the user group skilled in the e-mail related operations in a similar manner, time required for the transition varies between individuals. Therefore, in order to estimate the future transition of the usage features for a certain user, it is necessary to model how the usage features generally transits, and estimate the future usage features of the user to be analyzed using the modeled transition, which is to be a reference.

The present invention is suggested in light of such circumstances, and its purpose is to provide a device and a method that can estimate the transition of the usage of the user on a terminal device.

### Solution to Problem

A first usage estimation device of the present invention, when a trajectory made by dividing operation history information of a user on a terminal device by time, calculating a group of feature amount representing usage for each piece of the operation history information in each division section, and connecting points corresponding to the group of feature amount on a space based on the feature amount is referred to as a usage trajectory, compares the usage trajectory of each reference user calculated from the operation history information of a plurality of reference users with the usage trajectory calculated from the operation history information of a user to be analyzed, and estimates future usage of the user to be analyzed from the usage trajectory of the reference user that is similar to the usage trajectory of the user to be analyzed.

### Advantageous Effects of Invention

According to the present invention, it is possible to estimate future usage of a user on a terminal device based on the operation history information of the user for terminal device.

### BRIEF DESCRIPTION OF DRAWINGS

FIG. 1 is a block diagram of a first embodiment of the present invention;

FIG. 2 is a view illustrating an example of operation history according to the present invention;

FIG. 3 is a flowchart illustrating a process example of the first embodiment of the present invention;

FIG. 4A is an explanatory view of an operating principle of the first embodiment of the present invention;

FIG. 4B is an explanatory view of an operating principle of the first embodiment of the present invention;

FIG. 4C is an explanatory view of an operating principle of the first embodiment of the present invention;

FIG. 5 is a block diagram of a second embodiment of the present invention;

FIG. 6 is a flowchart illustrating an operation example of the second embodiment of the present invention;

FIG. 7A is an explanatory view of an operating principle of the second embodiment of the present invention;

FIG. 7B is an explanatory view of an operating principle of the second embodiment of the present invention;

FIG. 7C is an explanatory view of an operating principle of the second embodiment of the present invention;

FIG. 7D is an explanatory view of an operating principle of the second embodiment of the present invention;

FIG. 8 is a block diagram of a third embodiment of the present invention;

FIG. 9 is a flowchart illustrating an operation example of the third embodiment of the present invention;

FIG. 10 is a block diagram of an example of a recommendation information determination unit according to the third embodiment of the present invention;

FIG. 11 is a block diagram of a fourth embodiment of the present invention;

FIG. 12 is a block diagram of a fifth embodiment of the present invention;

FIG. 13 is a block diagram of a sixth embodiment of the present invention; and

FIG. 14 is a view illustrating a transition example of usage of a user on a terminal device.

### DESCRIPTION OF EMBODIMENTS

Next, embodiments of the present invention are described in detail with reference to the drawings.

### First Embodiment

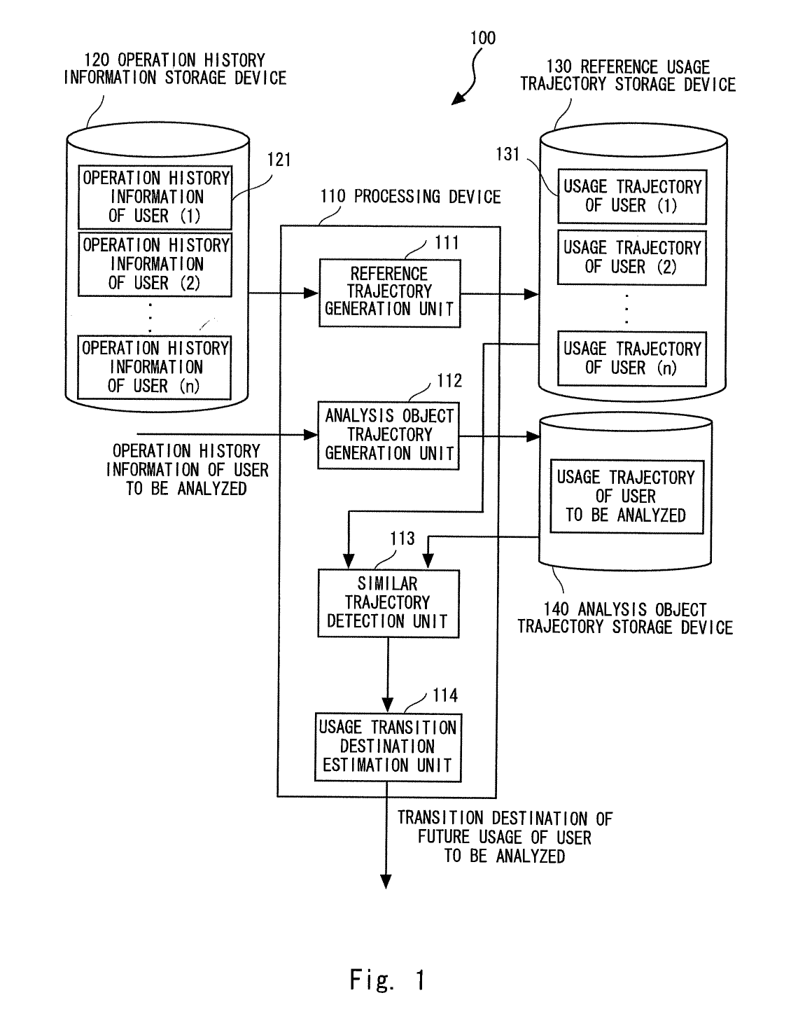

Referring to FIG. 1, a usage estimation device 100 according to a first embodiment of the present invention is composed of a processing device 110, an operation history information storage device 120 connected thereto, a reference usage trajectory storage device 130, and an analysis object trajectory storage device 140.

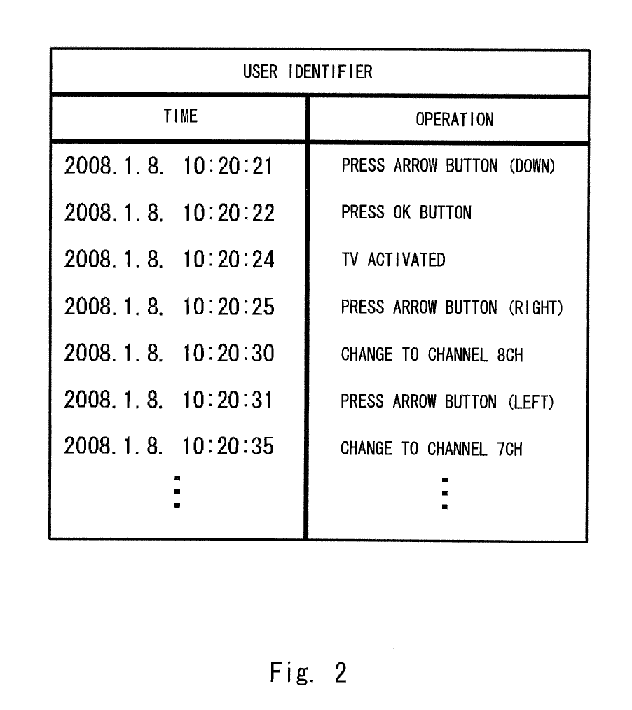

The operation history information storage device 120 is a database which accumulates operation history information 121 of multiple reference users on a terminal device (for example a certain kind of mobile phone) to be analyzed of the usage. A user identifier for distinguishing from operation history information of other users is included in the operation history information of a certain person, and as shown in FIG. 2, time and an operation at that time is grouped and saved. As for the kind of the operation to remain in the history, it may be the one helpful for estimating the usage of individual user (proficiency level of the operation and the kind of application to use). For example, it may be a detailed level such as a press on each button existing on the terminal device or a level such as the kind of an activated application. The application here indicates a functional unit provided by the terminal device. For example, in a mobile phone, it may be an e-mail function, a telephone function, a scheduler function, a television reception function, a payment function such as electronic money, a function using GPS, and various Web services including train transfer guide. It may be more detailed functional unit (such as a decorated e-mail and picture attachment to an e-mail). Moreover, in a personal computer, it may be word processor software, spreadsheet software, presentation software, e-mail software, other programs, or the like. This can be finer functional units (for example a column setting function, a table of contents generation function, and a spell correction function). Various functions which can be called from the terminal device also in the terminal device of other kinds are applicable.

The processing device 110 is a device that estimates and outputs the future usage of the user to be analyzed according to the operation history information 121 stored to the operation history information storage device 120 and the operation history information of the user to be analyzed, which is separately input, and includes a reference trajectory generation unit 111, an analysis object trajectory generation unit 112, a similar trajectory detection unit 113, and a usage transition destination estimation unit 114.

The reference trajectory generation unit 111 inputs the operation history information 121 of each user from the operation history information storage device 120, generates the usage trajectory 131 for each user, and saves it to the reference usage trajectory storage device 130. At this time, the usage trajectory of the user is a trajectory made by dividing the operation history information of the user by an interval of constant time T from first use, calculating a group of feature amount that represents the usage for each piece of operation history information in each division section, and connecting the points corresponding to the group of the feature amount on a space that is based on each of feature amount (the space hereinafter referred to as a usage space) in time order. If there is a fraction that cannot be divided by the time T, the last section is left as a section shorter than T or included in the previous section. Suppose that there are P feature amounts to use, which are x1, 2, . . . and xp, the group of the feature amount of the usage in one division section is represented by vectors that has x1, x2, . . . and xp as elements. This vector is referred to as a feature amount vector V. As the time interval of each division section is T, the user usage trajectory is represented by a curve that connects the feature amount vectors V(T0), V(T1), V(T2), . . . , and V(Tn) in time order.

As the feature amount to express the usage of the user, there are the number of activated applications, a list of activated applications, time until reaching an application, the number of button operations, menu residence time, and an input amount to an application. It is arbitrary what kind and how many of the feature amount to use. Further, the constant time T is a previously determined period, such as several days, weeks, and months.

As a method of calculating the group of the feature amount representing the usage for each division section of operation history information, for example for operation history information in a section (t2−t1=1) from time t1 to time t2, there is a method of extracting previously determined multiple feature amounts, such as the number of activated applications, from the operation history information in the period t, which is immediately before the time t2. Here, the period t may be t=T, t<T, or t>T. Moreover, t may be different depending on the kind of the feature amount.

The analysis object trajectory generation unit 112 generates a usage trajectory 141 of the user to be analyzed from the operation history information of the user to be analyzed, and saves it to the analysis object trajectory storage device 140. The usage trajectory 141 of the user to be analyzed is the trajectory made by dividing the operation history information of the user to be analyzed by certain time T in a similar manner as the method in the reference trajectory generation unit 111, calculating the group of feature amount that represents the usage by each piece of the operation history information of each division section, and connecting the points corresponding to the group of the feature amount on the space based on those feature amount.

The similar trajectory detection unit 113 compares the usage trajectory 141 of the user to be analyzed, which is stored to the analysis object trajectory storage device 140, with the usage trajectory 131 of each reference user, which is stored to the reference usage trajectory storage device 130, and detects the usage trajectories 131 of one or more users that are similar to the usage trajectory 141 of the user to be analyzed. As the method to check whether the usage trajectories are similar, the method to align the starting points of the trajectories and check a difference between the trajectories can be used. As the difference between the trajectories, it is possible to use a sum of the difference between the feature vectors at the point where the elapsed time from the starting point is the same. The difference of corresponding feature vectors can be expressed by a distance between the feature vectors. Further, as other methods of checking whether the usage trajectories are similar, there is a method to match a curve characteristic amount (curvature change, a Fourier descriptor, etc.) of each trajectory. Here, the Fourier descriptor is a method to express the shape of a closed curve, and can be used when both of the usage trajectories are closed curves.

The usage transition destination estimation unit 114 is a means to estimate the future usage of the user to be analyzed from a trajectory part which corresponds to the last point or later of the usage trajectory of the user to be analyzed in the usage trajectories of one or more users, which are detected by the similar trajectory detection unit 113. Specifically, if the last feature vector of the usage trajectory of the user to be analyzed is to be determined as the one at the time point when Ti time has elapsed from the first use, among the points on the usage trajectories of one or more users detected by the similar trajectory detection unit 113, the point of the time point when Ti+Δt time has elapsed from the first use is determined as the transition destination of the feature of the future usage of the user to be analyzed, and information that identifies this point (for example, the information that identifies which point on which usage trajectory) is output. Here, Δt may be a value which defines how far temporally the usage is to be estimated, and may be a fixed value or a changeable value.

Note that instead of or in addition to outputting information that identifies the point on the user usage trajectory, which is detected by the similar trajectory detection unit 113, the usage transition estimation unit 114 may output the feature amount of that point. Further, as a result that the usage trajectories of multiple users are detected by the similar trajectory detection unit 113, if the transition destination is multiple points, an average value of the feature amounts of those points or a probability distribution in the usage space may be calculated and output.

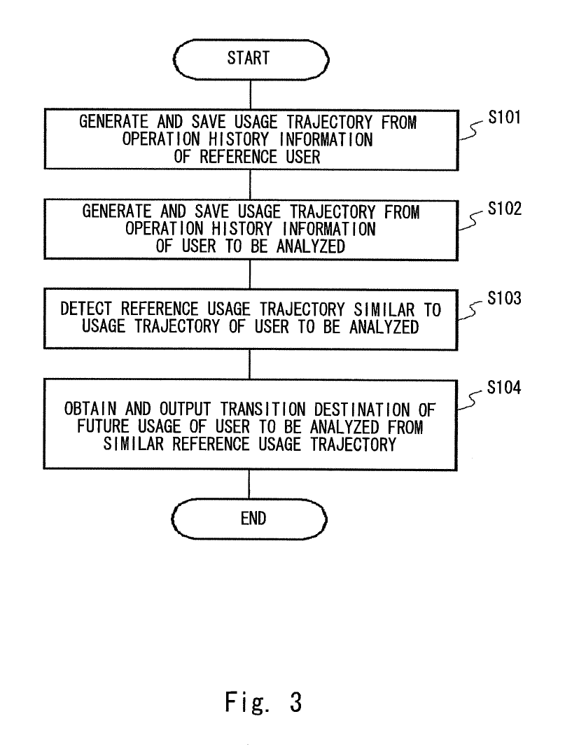

Next, an operation of this embodiment is explained with reference to the flowchart shown in FIG. 3.

First, the reference trajectory generation unit 111 reads the operation history information 121 of multiple users from the operation history information storage device 120, calculates a usage trajectory 131 for each piece of the operation history information 121 of each user, and saves it to the reference usage trajectory storage device 130 (step S101 of FIG. 3).

Next, the analysis object trajectory generation unit 112 externally inputs the operation history information of the user to be analyzed, calculates the usage trajectory 141 of this operation history information, and saves it to the analysis object trajectory storage device 140 (step S102 of FIG. 3).

Next, the similar trajectory detection unit 113 compares the usage trajectory 141 of the user to be analyzed, which is stored to the analysis object trajectory storage device 140, with the usage trajectory 131 of each user, which is stored to the reference usage trajectory storage device 130, and detects the user usage trajectory 131 similar to the usage trajectory 141 of the user to be analyzed (step S103).

Next, the usage transition destination estimation unit 114 obtains and outputs the future transition destination of the usage of the user to be analyzed based on the usage trajectory 131 of the user to be a reference, which is detected by the similar trajectory detection unit 113 (step S104).

Note that unless the operation history information 121 stored to the operation history information storage device 120 is modified, step S101 should be performed only for the first time. Therefore, if the operation history information of the user to be analyzed is repeatedly input, the process may be repeated from step 102.

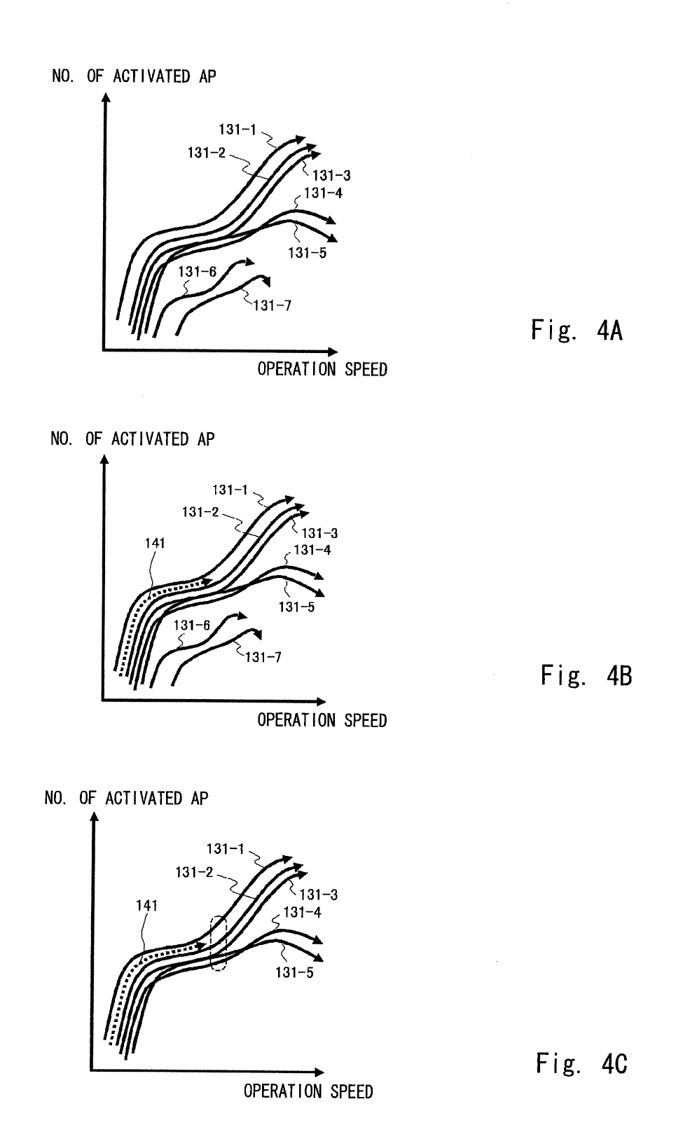

FIG. 4A illustrates an image in which the usage trajectories 131 of multiple reference users are mapped to the usage space using the operation speed of button operation, for example, and the number of applications as the feature amount. Although two feature amounts, which are the operation speed and the number of activated applications, are used here, the kind and the number of the feature amount to use are arbitrary. One arrowed curve in the drawing indicates a usage trajectory of one user. Further, FIG. 4B is a view in which the usage trajectory 141 of the user to be analyzed is added to FIG. 4A. The similar trajectory detection unit 113 detects the user usage trajectory 131 that is similar to the usage trajectory 141 of the user to be analyzed. In the case of FIG. 4B, usage trajectories 131-1 to 131-5 have similar trajectories to the first to the last usage trajectory 141 of the user to be analyzed. Therefore, the similar trajectory detection unit 113 outputs the usage trajectories 131-1 to 131-5 as a detection result. The usage transition destination estimation unit 114 estimates the transition destination of the future usage of the user to be analyzed from the usage trajectories 131-1 to 131-5. Specifically, a point on the user usage trajectories 131-1 to 131-5 at a time point indicated by a dashed line circle in FIG. 4C when predetermined time elapsed from the last time point of the usage trajectory 141 of the user to be analyzed is output as the transition destination.

Next, an effect of this embodiment is described.

According to this embodiment, for the user to be analyzed whose operation history information at a certain point is stored, it is possible to estimate the usage of the user to be analyzed thereafter based on the operation history information of multiple reference users on the terminal device. The reason is that the usage trajectory that is similar to the usage trajectory generated from the operation history information of the user to be analyzed is detected among the usage trajectories generated from the operation history information of the reference user, and the future usage of the user to be analyzed is estimated from the trend of the detected usage trajectory, using that it is highly possible that multiple usage trajectories which have similar trajectories at the certain point will change in a similar manner in the future.

### Second Embodiment

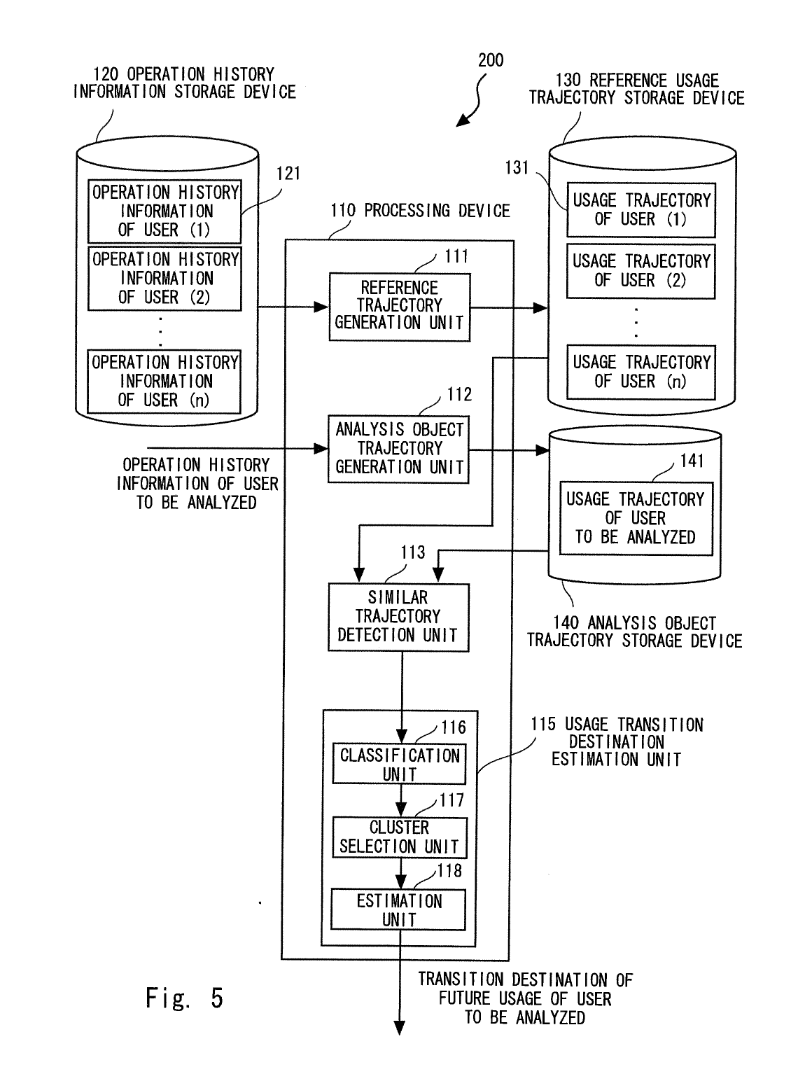

Referring to FIG. 5, a usage estimation device 200 according to a second embodiment of the present invention is different as compared to the usage estimation device 100 according to the first embodiment shown in FIG. 1, in that the processing device 110 includes a usage transition destination estimation unit 115 instead of the usage transition destination estimation unit 114.

The usage transition destination estimation unit 115 is different from the usage transition destination estimation unit 114 of the first embodiment without a narrow-down function in the point of narrowing down one or more usage trajectories detected by the similar trajectory detection unit 113 by a predetermined condition, and estimating the future usage of the user to be analyzed from the narrowed down usage trajectories. The usage transition destination estimation unit 115 is composed of a classification unit 116, a cluster selection unit 117, and an estimation unit 118.

The classification unit 116 is a means to classify usage trajectories 131 of one or more users to be references, which are detected by the similar trajectory detection unit 113, into one or more clusters composed of similar usage trajectories. Specifically, for one or more detected usage trajectories 131, starting points of the trajectories are aligned and a difference between the trajectories is checked, in order to classify the ones with a close difference in the trajectories into one cluster. As for the difference between the trajectories, a sum of the differences between corresponding feature vectors can be used. The difference of corresponding feature vectors can be expressed by a distance between the feature vectors. Further, as other methods of checking whether the usage trajectories are similar, there is a method to match a curve characteristic amount (curvature change, a Fourier descriptor, etc.) of each trajectory.

The cluster selection unit 117 is a means to select a cluster that satisfies the predetermined condition among one or more clusters classified by the classification unit 116. For the predetermined condition, as an optimistic condition, the condition to include the usage trajectory of the user who masters the terminal device better may be used. On the contrary, as a pessimistic condition, the condition to include the usage trajectory of the user who has not mastered the terminal device may be used. Hereinafter, a specific evaluation method is described with a case of using the condition to include the usage trajectory of the user who masters the terminal device better as an example.

There are following two methods as the method to evaluate whether it is the usage trajectory of the user who masters the terminal device better.

a) A method of evaluation based on the proficiency level
b) A method of evaluation based on a user's satisfaction level

The method of evaluation based on the proficiency level uses that the user who masters the terminal device better generally has a higher proficiency level. Whether the proficiency level is high or not is evaluated by analyzing whether the usage trajectory of the user is close to a desirable direction. The desirable direction is that, for example, more applications in the case of the number of activated applications, and more variations in the case of the list of activated applications. Further, the time until reaching to the application is better to be shorter, and the menu residence time is better to be shorter. From these feature amounts, an evaluation value J indicating whether each of them is getting close to the desirable directions is calculated from these feature amounts, and the cluster including the usage trajectory that has a larger evaluation value J is selected. For example, if the feature amount that is desirably small is {an}(n=1, . . . N) and the feature amount that is desirably large is {bm}(m=1, . . . M), the evaluation value J can be provided by the following formula.

J=Σ(1/an)²+Σ(bm)² (1)

The cluster selection unit 117 calculates the evaluation value J of each cluster generated by the classification unit 116 according to the operation history information used for generation of the usage trajectory of the user who belongs to the cluster, and selects the cluster with the largest evaluation value J.

On the other hand, the method of evaluation based on the satisfaction level of the user uses the causal relationship in which satisfied users tend to master the terminal device better. The satisfaction level of the user is collected by sending out a questionnaire to the users, and identified by, for example, the relationship with the operation history in the operation history information storage device 120 or another storage device, so as to enable identification of what time point of the user satisfaction level it is.

For each cluster generated by the classification unit 116, the cluster selection unit 117 reads the satisfaction level of the user relating to the operation history information, which is used to generate the usage trajectory of the user who belongs to the cluster from the operation history information storage device 120 or the like, calculates an index value of the user satisfaction level for each cluster by taking an average, and selects the cluster with the largest evaluation value J. The user satisfaction level to use is the user satisfaction level collected after a completion time point of the operation history information of the user to be analyzed.

The estimation unit 118 is a means to estimate the transition destination of the future usage of the user to be analyzed from the usage trajectories of one or more reference users included in the cluster, which are selected by the cluster selection unit 117.

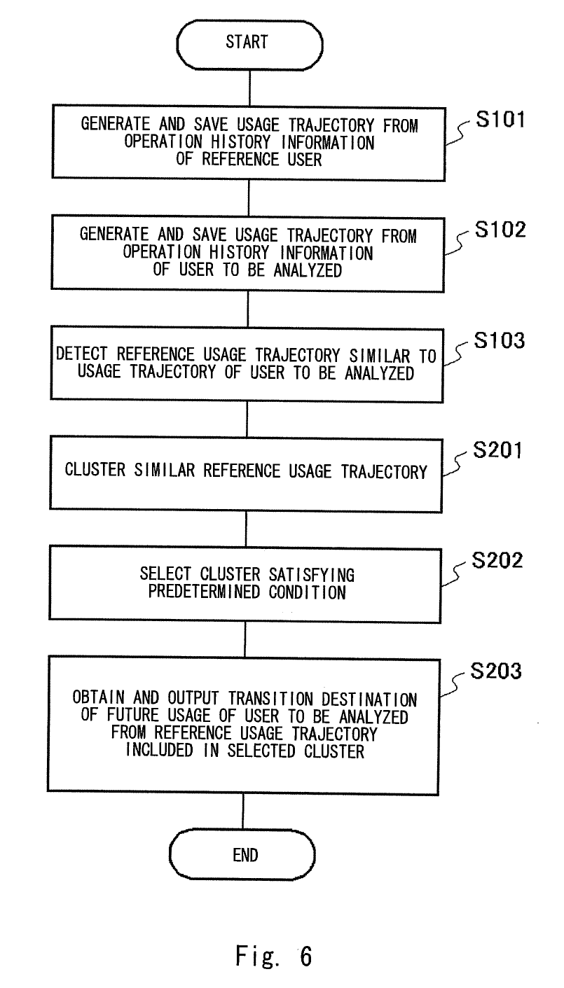

Next, an operation of this embodiment is explained with reference to the flowchart of FIG. 6.

First, generation of the usage trajectory 131 of each user by the reference trajectory generation unit 111, save to the reference usage trajectory storage device 130 (step S101 of FIG. 6), generation of the usage trajectory 141 of the user to be analyzed by the analysis object trajectory generation unit 112 and save to the analysis object trajectory storage unit 140 (step S102), and detection of the usage trajectory 131 of the user that is similar to the usage trajectory 141 of the user to be analyzed by the similar trajectory detection unit 113 (step S103), are performed. These processes are the same as the first embodiment.

Next, the classification unit 116 of the usage transition destination estimation unit 115 classifies the usage trajectories 131 of one or more users to be references, which are detected by the similar trajectory detection unit 113, into one or more clusters composed of similar reference usage trajectories (step S201). Next, the cluster selection unit 117 selects the cluster which satisfies the predetermined condition from one or more clusters classified by the classification unit 116 (step S202). Next, the estimation unit 118 estimates and outputs the transition destination of the future usage trajectory of the user to be analyzed from the usage trajectories of one or more users which are included in the cluster selected by the cluster selection unit 117 (step S203).

Note that unless the operation history information 121 stored to the operation history information storage device 120 is modified, step S101 should be performed only for the first time. Therefore, if the operation history information of the user to be analyzed is repeatedly input, the process may be repeated from the step 102.

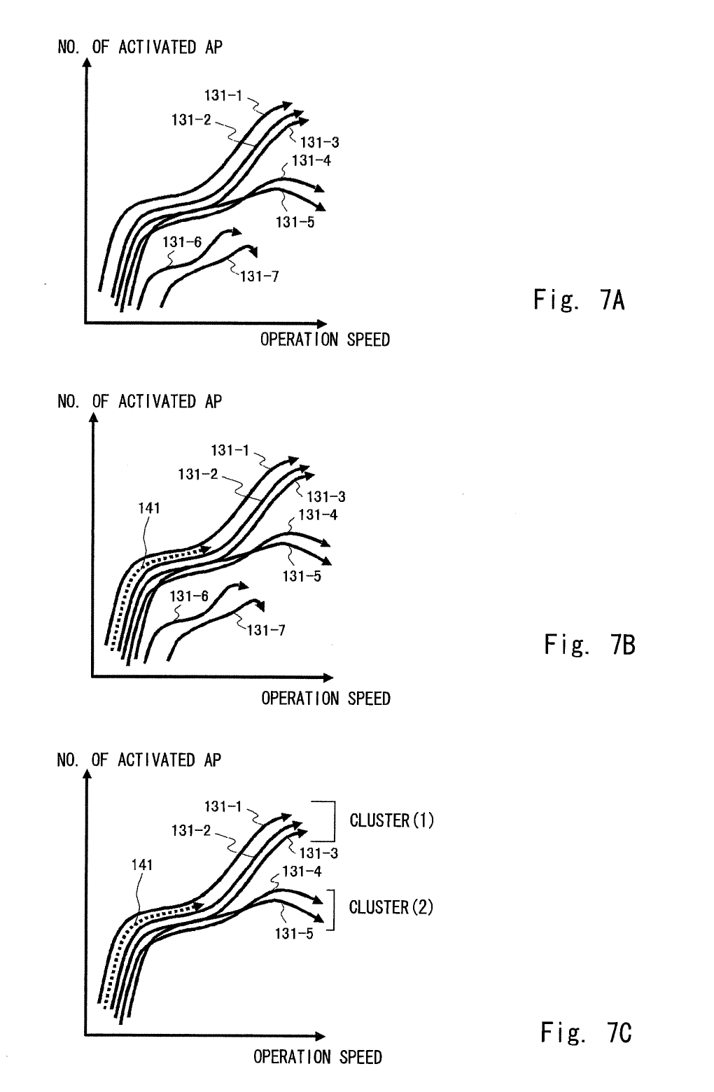

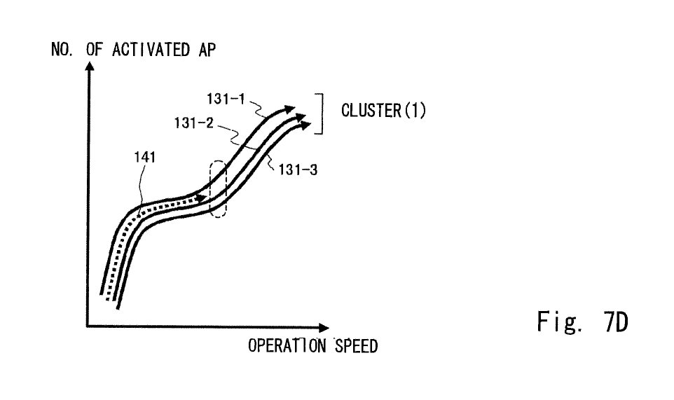

FIG. 7A illustrates an image of mapping the usage trajectories 131 of multiple users to be references to a usage space using two of the operation speed, such as button operation, and the number of activated applications as the feature amount, in a similar manner as FIG. 4A. Further, FIG. 7B is a view in which the image of the usage trajectory 141 of the user to be analyzed is added to FIG. 7A. In a similar manner as FIG. 4B, the similar trajectory detection unit 113 detects usage trajectories 131-1 to 131-5 as the usage trajectory 131, which is similar to the usage trajectory 141 of the user to be analyzed.

FIG. 7C shows a result of clustering the similar usage trajectories 131-1 to 131-5 by the closeness of the usage. In this example, they are classified into a cluster 1 including the usage trajectories 131-1 to 131-3 and a cluster 2 including the usage trajectories 131-4 to 131-5. FIG. 7D shows an example of selecting the clusters on the condition of including the usage trajectory of the user who masters the terminal device better. Since the cluster 1 is in the state of better master in aspects of both the operational speed and the number of activated applications, the cluster 1 is selected. The estimation unit 118 estimates the transition destination of the user to be analyzed from the usage trajectory 131-1 to 131-3 of the user who belongs to the cluster 1. Specifically, a point on the usage trajectories 131-1 to 131-3 at a time point indicated by the dashed line circle in FIG. 7D, which is the time point when predetermined time has elapsed from the last point of the usage trajectory 141 of the user to be analyzed, is output as the transition destination.

Next, an effect of this embodiment is described.

According to this embodiment, at the same time as achieving the similar effect as the first embodiment, there is an effect of narrowing down the usage trajectory to use for the estimation by the predetermined condition, if the usage trajectories of multiple users detected by the similar trajectory detection unit 113 change to a different direction after the operation history completion point of the user to be analyzed.

### Third Embodiment

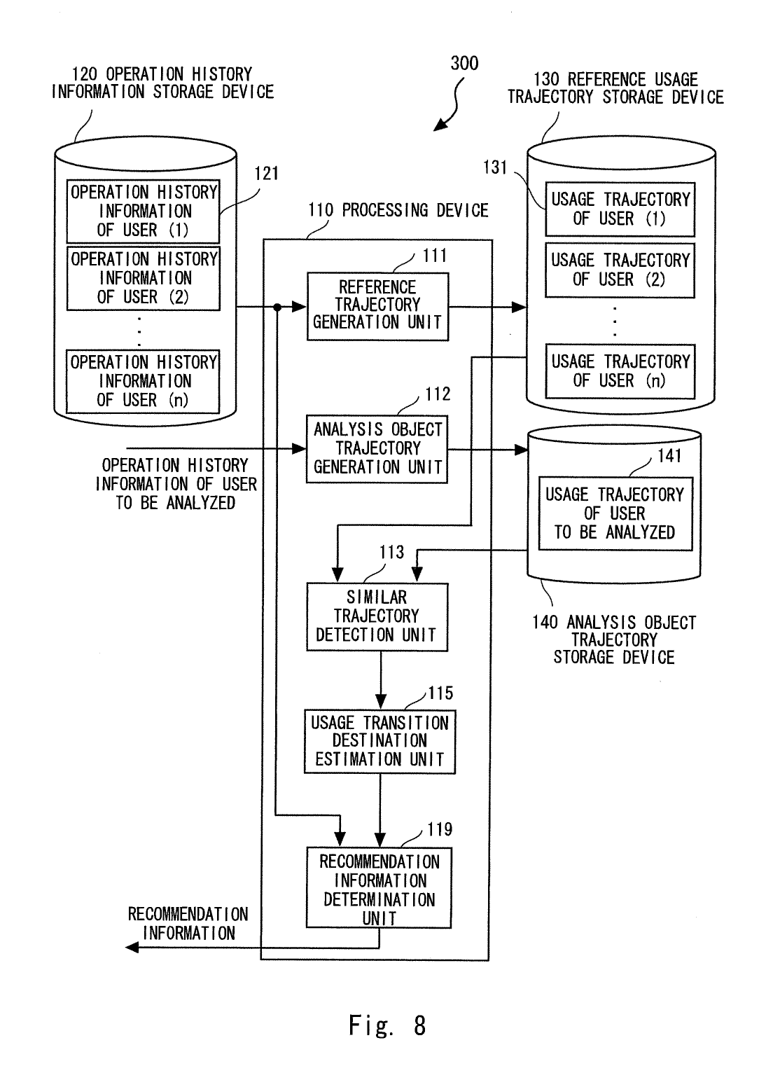

Referring to FIG. 8, a usage estimation device 300 according to a third embodiment of the present invention is a device in which a recommendation function of a utilization application for a user to be analyzed is added to the usage estimation device 200 according to the second embodiment shown in FIG. 5, and is different as compared to the usage estimation device 200 according to the second embodiment, in that the processing device 100 further includes a recommendation information determination unit 119 in addition to the reference trajectory generation unit 111, the analysis object trajectory generation unit 112, the similar trajectory detection unit 113, and the usage transition destination estimation unit 115.

The recommendation information determination unit 119 is a means that, at the point estimated as the transition destination of the future usage of the user to be analyzed by the usage transition destination estimation unit 115, extracts the application that has been used by the reference user from the operation history information of the reference user, and recommends all or a part of the extracted applications to the user to be analyzed. Specifically, it is a means to recommend all or a part of the applications that have been used by the reference user, who has the same usage as the future usage of the user to be analyzed, to the user to be analyzed. As the method to limit to a part to be recommended, there is a method to limit to the application that has been used by more reference users who belong to the cluster selected by the usage transition destination estimation unit 115, a method to limit to the application in which the number of activation is greater than or equal to a certain value, a method to limit to the application that has not been used by the user to be analyzed, and a method combining those.

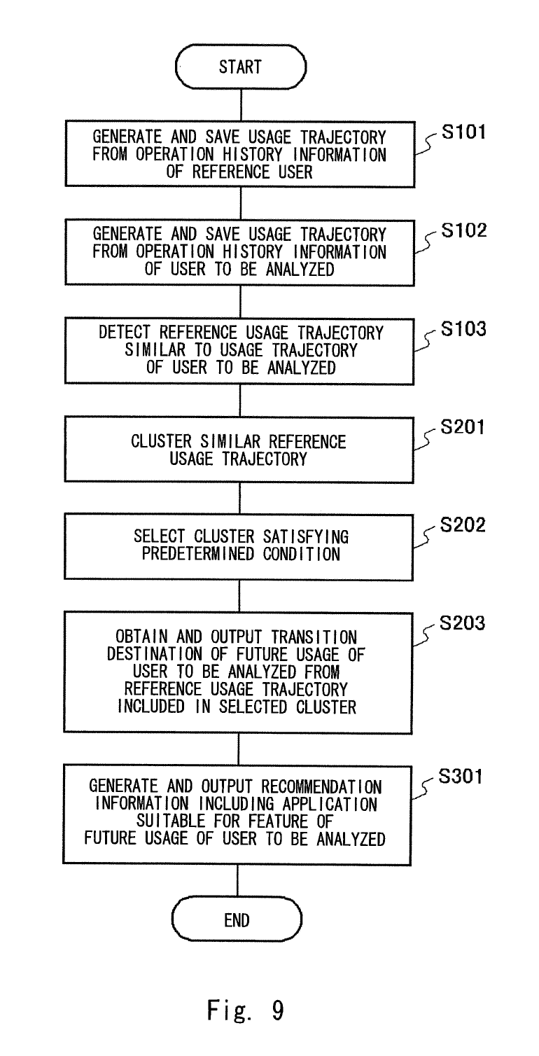

Next, an operation of this embodiment is explained with reference to the flowchart of FIG. 9.

First, generation of the usage trajectory 131 of each user by the reference trajectory generation unit 111, save to the reference usage trajectory storage device 130 (step S101 of FIG. 9), generation of the usage trajectory 141 of the user to be analyzed by the analysis object trajectory generation unit 112 and save to the analysis object trajectory storage unit 140 (step S102), detection of the usage trajectory 131 of the user that is similar to the usage trajectory 141 of the user to be analyzed by the similar trajectory detection unit 113 (step S103), clustering of the similar reference usage trajectory by the usage transition destination estimation unit 115 (step S201), selection of the cluster (step S202), and estimation of the transition destination of the future usage of the user to be analyzed (step S203), are performed. These processes are the same as the second embodiment.

Next, at a point on the reference usage trajectory which is estimated by the usage transition destination estimation unit 115 as the transition destination of the future usage of the user to be analyzed, the recommendation information determination unit 119 recommends to the user to be analyzed, all or a part of the applications including the usage history described in the user operation history information 121 that is used for the generation thereof (step S301).

For example, if the usage transition destination estimation unit 115 estimates that a point on the usage trajectories 131-1 to 131-3 indicated by the dashed line circle of FIG. 7D as the transition destination of the future usage of the user to be analyzed, the recommendation information determination unit 119 searches in the operation history information storage device 120 for an application name in which the usage history thereof is recorded in the operation history information 121 of reference users 1 to 3 used to calculate those points, and outputs it as recommendation information.

Note that unless the operation history information 121 stored to the operation history information storage device 120 is modified, step S101 should be performed only for the first time. Therefore, if the operation history information of the user to be analyzed is repeatedly input, the process may be repeated from the step 102.

Next, an example of the recommendation information determination unit 119 in this embodiment is described.

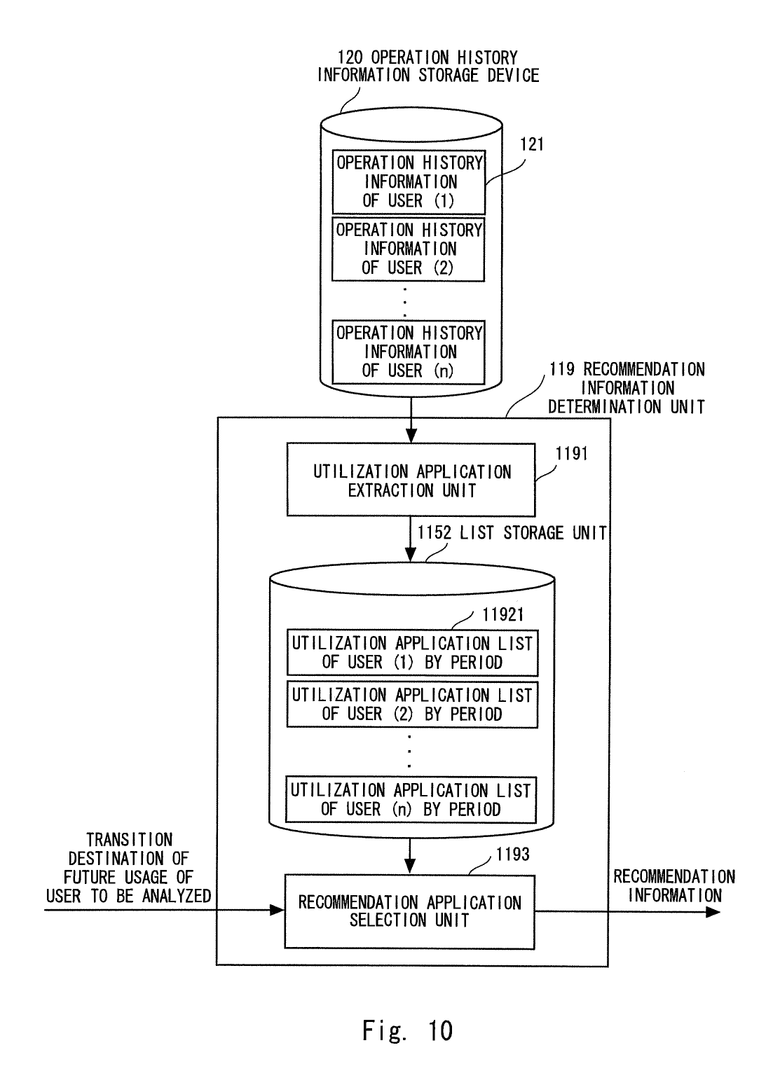

Referring to FIG. 10, the recommendation information determination unit 119 of this example is composed of a utilization application extraction unit 1191, a list storage unit 1192, and a recommendation application selection unit 1193.

For each piece of the user operation history information 121 stored to the operation history information storage device 120, the utilization application extraction unit 1191 extracts what kind of application the user uses from the operation history information 121 by a certain period T, creates a utilization application list 11921 for each user by each period, and saves it to the list storage unit 1192. Specifically, the user operation history information is read from the operation history information storage device 120 for each user, the operation history information is divided by the period T interval, and all the application names that are activated from each piece of the divided operation history information are extracted and listed. At this time, the list ranked by the number of usage may be created and saved.

The list storage unit 1192 is a database that holds the utilization application list 11921 for each user by each period, which is created by the utilization application extraction unit 1191.

In response to the information that identifies the user identifier and the point on the usage trajectory of the user to be a reference as the information of the transition destination of the user to be analyzed received from the usage transition destination estimation unit 115, the recommendation application selection unit 1193 searches for the utilization application lists by each period of the user to be the reference from the list storage unit 1192, and further searches from these utilization application lists for the utilization application list of the period corresponding to the point on the usage trajectory. Then, the recommendation information, which includes all or a part of the applications described in the utilization application list as the application to be recommendation candidates, is created and output. At this time, the applications that have been already used may be extracted from the operation history information of the user to be analyzed and the application that has been already used by the user to be analyzed among the applications described in the utilization application list may be excluded from the recommendation candidates.

The creation of the utilization application list 11921 of the user for each period by the utilization application extraction unit 1191 may be started after the transition destination of the usage of the user to be analyzed is input to the recommendation information determination unit 119 or may be started beforehand without waiting for the input. In the case of the latter case, necessary computational complexity at the time of recommendation can be reduced.

Next, an effect of this embodiment is explained.

According to this embodiment, at the same time as achieving the similar effect as the second embodiment, it is possible to recommend the application in which the user can reasonably perform when encouraging improvement of the usage of the user to be analyzed. The reason is that the application is recommended which has been used by the reference user of the similar usage as the future usage of the user to be analyzed.

### Fourth Embodiment

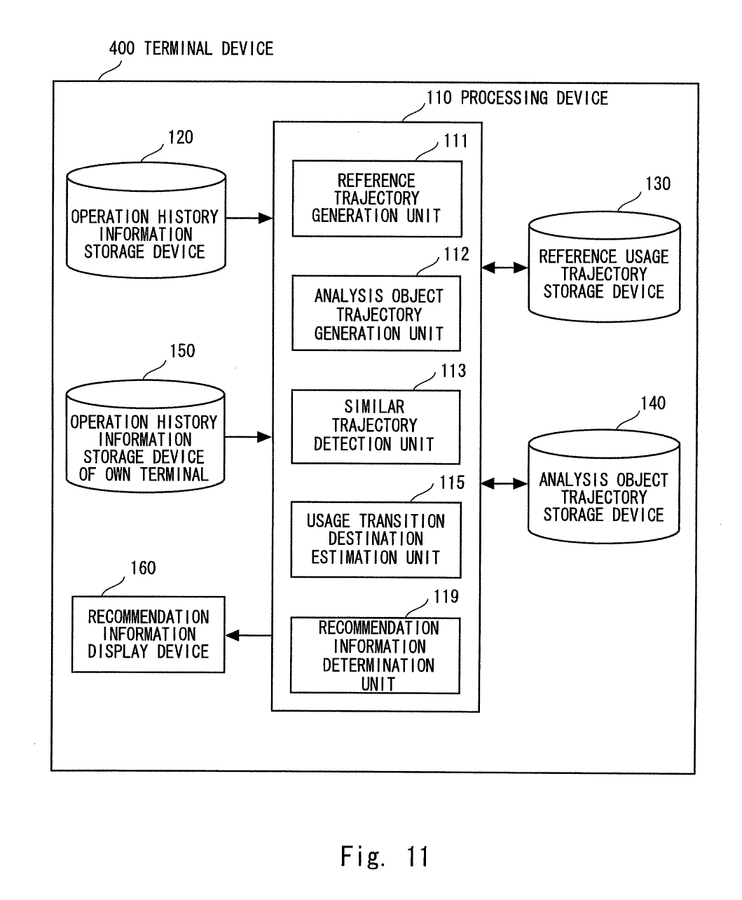

Referring to FIG. 11, according to a fourth embodiment of the present invention, a terminal device 400 of the user to be analyzed includes the processing device 110 including the reference trajectory generation unit 111, the analysis object trajectory generation unit 112, the similar trajectory detection unit 113, the usage transition destination estimation unit 115, and the recommendation information determination unit 119, the operation history information storage device 120, the reference usage trajectory storage device 130, and the analysis object trajectory storage device 140 of the third embodiment, and further includes a storage device 150 that stores operation history information of own terminal and a display device 160 that displays the recommendation information.

The reference trajectory generation unit 111 performs the operation explained in the third embodiment at an appropriate timing such as when starting a first usage of the terminal device 400, generates the usage trajectory of the user to be a reference based on the operation history information stored to the operation history information storage device 120, and store it to the reference usage trajectory storage device 130. Further, at an appropriate timing that the user to be analyzed is using the terminal device 400, the analysis object trajectory generation unit 112 reads the operation history information of own terminal from the storage device 150, performs the operation explained in the third embodiment, generates the usage trajectory of the user to be analyzed, and stores it to the analysis object trajectory storage device 140. Next, the similar trajectory detection unit 113 detects the usage trajectory of the user to be a reference, which is similar to the usage trajectory of the user to be analyzed, the usage transition destination estimation unit 115 estimates the transition destination of the usage of the user to be analyzed based on the detected usage trajectory by the method explained in the third embodiment, the recommendation information determination unit 119 performs the operation described in the third embodiment, and determines the application to be a recommendation candidate. Then, the recommendation information determination unit 119 outputs the recommendation information including application names of the recommended candidates to the recommendation information display device 160. The recommendation information display device 160 presents the input recommended information to the user to be analyzed by displaying it on the display screen.

According to this embodiment, from the generation of the usage trajectories of multiple reference users, the evaluation of the transition destination of the usage of the user to be analyzed using the trajectories, to the determination and the display of the recommended information, all can be performed inside the terminal device.

### Fifth Embodiment

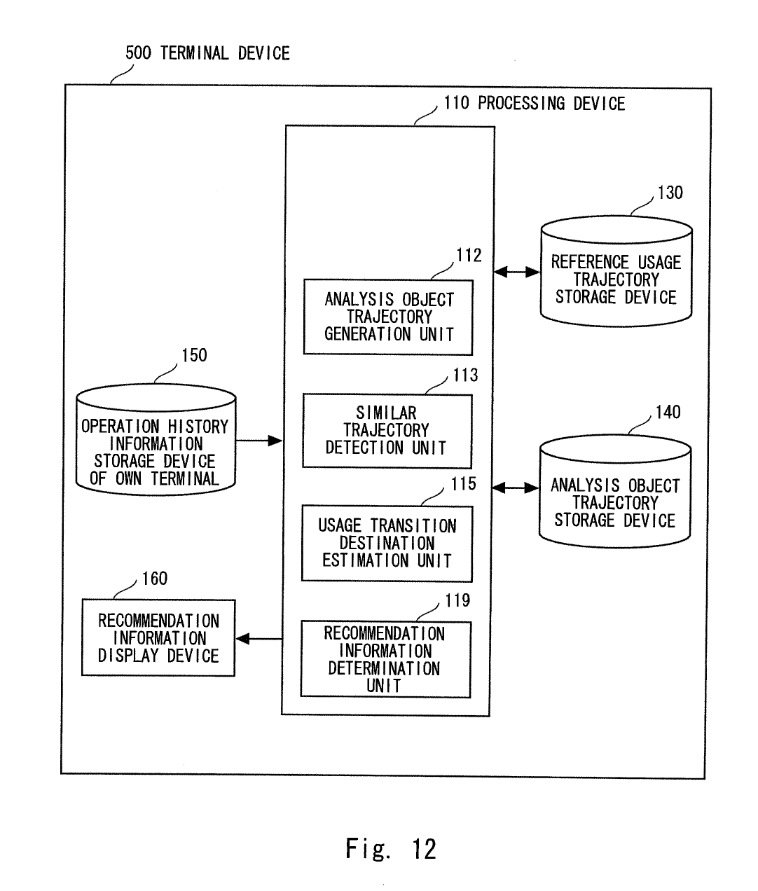

Referring to FIG. 12, according to a fifth embodiment of the present invention, a terminal device 500 of the user to be analyzed includes the processing device 110 including the reference usage trajectory storage device 130 that stores the user trajectories of multiple users created in a similar method as the method in the third embodiment, the analysis object trajectory generation unit 112, the similar trajectory detection unit 113, the usage transition destination estimation unit 115, and the recommendation information determination unit 119, and further includes the storage device 150 that stores operation history information of own terminal and a display device 160 that displays the recommendation information. Note that the list storage unit 1192 that holds the utilization application list 1192 for each user by each period, which is explained with reference to FIG. 10, is embedded in the recommendation information determination unit 119.

At an appropriate timing that the user to be analyzed is using the terminal device 500, the analysis object trajectory generation unit 112 reads the operation history information of own terminal from the storage device 150, performs the operation explained in the third embodiment, generates the usage trajectory of the user to be analyzed, and stores it to the analysis object trajectory storage device 140. Next, the similar trajectory detection unit 113 detects the usage trajectory of the user to be a reference, which is similar to the usage trajectory of the user to be analyzed, the usage transition destination estimation unit 115 estimates the transition destination of the usage of the user to be analyzed based on the detected usage trajectory by the method explained in the third embodiment, the recommendation information determination unit 119 performs the operation described in the third embodiment, and determines the application to be a recommendation candidate. Then, the recommendation information determination unit 119 outputs the recommendation information including application names of the recommended candidates to the recommendation information display device 160. The recommendation information display device 160 presents the input recommended information to the user to be analyzed by displaying it on the display screen.

According to this embodiment, as the usage trajectory of the reference user externally generated is installed and used on the terminal device, it is possible to determine the transition destination of the usage of the user to be analyzed and generate the recommended information corresponding thereto even by a terminal device that has no function to generate the usage trajectories of multiple reference users.

### Sixth Embodiment

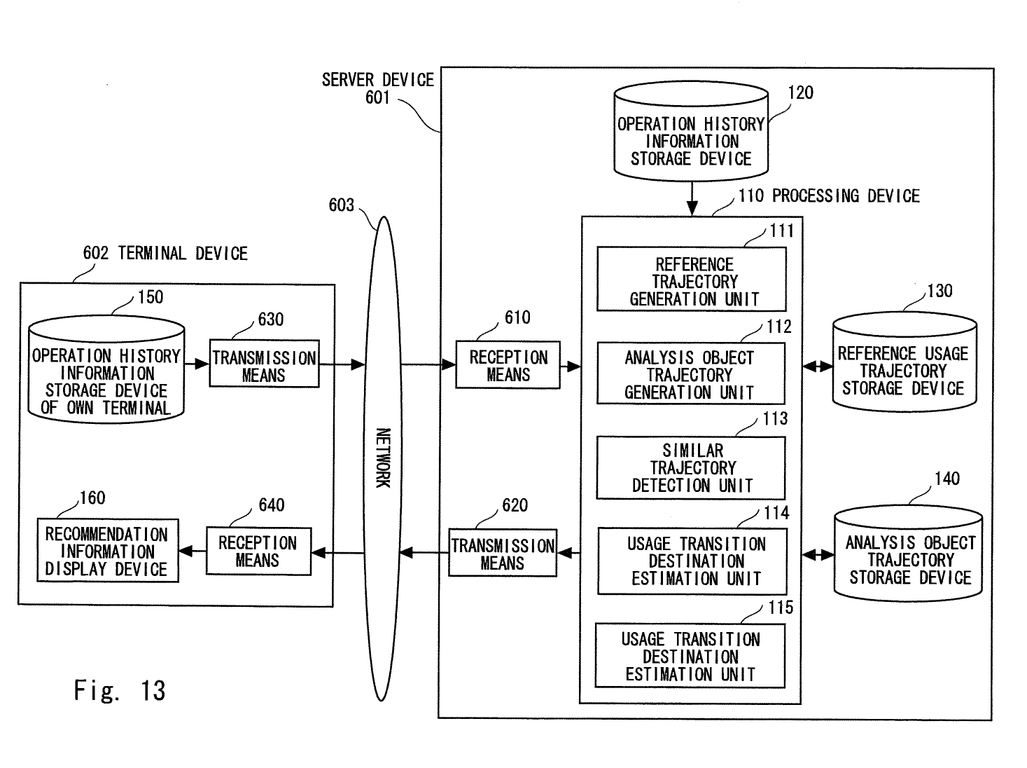

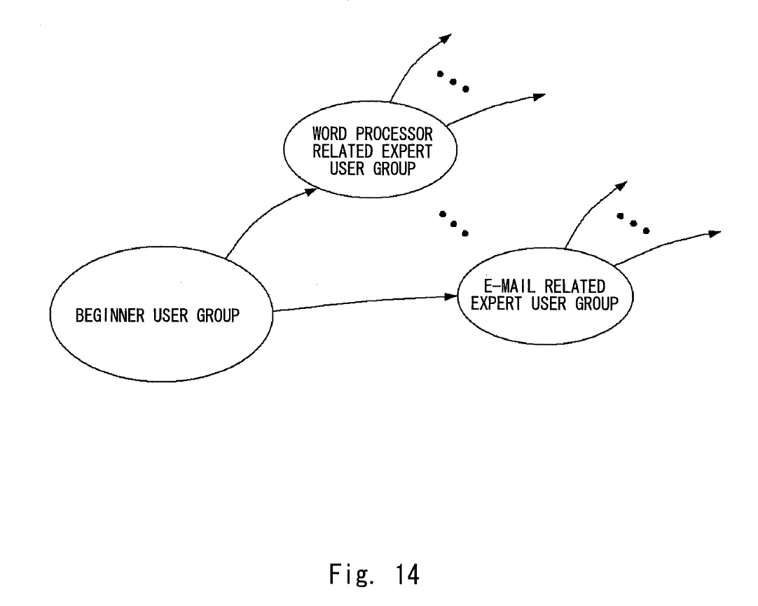

Referring to FIG. 13, a sixth embodiment of the present invention is composed of a server device 601 and a terminal device 602, which can mutually communicate via a network 603. The server device 601 includes the processing device 110 including the reference trajectory generation unit 111, the analysis object trajectory generation unit 112, the similar trajectory detection unit 113, the usage transition destination estimation unit 115, and the recommendation information determination unit 119, the operation history information storage device 120, the reference usage trajectory storage device 130, and the analysis object trajectory storage device 140 of the third embodiment. The terminal device 602 includes the storage device 150 that stores operation history information of own terminal and the display device 160 that displays the recommendation information. Further, the server device 601 includes a transmission means 620 and a reception means 610, which perform data communication with the terminal device 602 via the network 603, and the terminal device 602 includes a transmission means 630 and a reception means 640, which perform data communication with the server device 601 via the network 603.

The reference trajectory generation unit 111 of the server device 601 performs similar operation as the operation explained in the third embodiment at an appropriate timing, generates the usage trajectory of the user to be a reference based on the operation history information stored to the operation history information storage device 120, and stores it to the reference usage trajectory storage device 130.

The transmission means 630 of the terminal device 602 reads the operation history information from the storage device 150 at an appropriate timing that the user to be analyzed is using the terminal device 602, and transmits it to the server device 601 via the network 603. In the server device 601, the operation history information is received by the reception means 610, and input to the analysis object trajectory generation unit 112 of the processing device 110.

The analysis object trajectory generation unit 112 of the server device 601 performs similar operation as the operation described in the third embodiment and generates the usage trajectory of the usage trajectory of the user to be analyzed based on the input operation history information of the user to be analyzed, and stores it to the analysis object trajectory storage device 140. Next, the similar trajectory detection unit 113 detects the usage trajectory of the user to be a reference, which is similar to the usage trajectory of the user to be analyzed, the usage transition destination estimation unit 115 estimates the transition destination of the usage of the user to be analyzed based on the detected usage trajectory by the method explained in the third embodiment, the recommendation information determination unit 119 performs the operation described in the third embodiment, and determines the application to be a recommendation candidate. Then, the recommendation information determination unit 119 transmits the recommendation information including the application name or the like of the recommendation candidate to the terminal device 602 by the transmission means 620 via the network 603.

In the terminal device 602, the recommendation information transmitted from the server device 601 is received by the reception means 640, and is output to the recommendation information display device 160. The recommendation information display device 160 presents the input recommended information to the user to be analyzed by displaying it on the display screen.

Note that in this embodiment, although the operation history information of the user to be analyzed is transmitted from the terminal device 602 of the user to be analyzed to the server device 601, in a case that the terminal device 602 is a thin client terminal, the operation information is not saved to the terminal device 602, but saved to a server side of the thin client system. Therefore, there can be the embodiment for the server device 601 in which the operation history information of the user to be analyzed is obtained from the server side of the thin client system.

According to this embodiment, the future usage of the user who uses the terminal device can be estimated, and the service to recommend a suitable function to the user can be realized as a kind of Web service.

Although the embodiments of the present invention were described so far, the present invention is not limited only to the above examples, but various other additions and modifications can be made. Further, as for the usage estimation device of the present invention, the functions included therein can be achieved obviously by hardware, and also a computer and program. The program is provided in a recorded form in a computer readable storage medium such as a magnetic disk and a semiconductor memory, and read by the computer at the time of starting the computer, and by controlling the operation of the computer, the computer is made to function as a functional means such as the reference trajectory generation unit, the analysis object trajectory generation unit, the similar trajectory detection unit, the usage transition destination estimation unit, and the recommendation information determination unit in each of the abovementioned embodiment.

Although the present invention has been described referring to the embodiments, the present invention is not limited by above. Various changes that can be understood by a person skilled in the art within the scope of the invention can be made to the configuration and details of the present invention.

This application claims priority of Japanese application for patent 2008-190656 on Jul. 24, 2008, the entire disclosure of which is hereby incorporated by reference herein.

### INDUSTRIAL APPLICABILITY

The present invention can be applied to a system in which multiple users exist, for example a mobile phone, a personal computer, a particular application on a computer, an intranet system, an ATM and a KIOSK terminal, a hard disk recorder television, other information home appliance products, or the like.

### REFERENCE SIGNS LIST

100 USAGE ESTIMATION DEVICE
110 PROCESSING DEVICE
111 REFERENCE TRAJECTORY GENERATION UNIT
112 ANALYSIS OBJECT TRAJECTORY GENERATION UNIT
113 SIMILAR TRAJECTORY DETECTION UNIT
114 AND 115 USAGE TRANSITION DESTINATION ESTIMATION UNIT
116 CLASSIFICATION UNIT
117 CLUSTER SELECTION UNIT
118 ESTIMATION UNIT
120 OPERATION HISTORY INFORMATION STORAGE DEVICE
121 USER OPERATION HISTORY INFORMATION
130 REFERENCE USAGE TRAJECTORY STORAGE DEVICE
131 USER USAGE TRAJECTORY
140 ANALYSIS OBJECT TRAJECTORY STORAGE DEVICE
141 ANALYSIS OBJECT USER USAGE TRAJECTORY

1. A usage estimation device that, when a trajectory made by dividing operation history information of a user on a terminal device by time, calculating a group of feature amount representing usage for each piece of the operation history information in each division section, and connecting points corresponding to the group of feature amount on a space based on the feature amount is referred to as a usage trajectory,
compares the usage trajectory of each reference user calculated from the operation history information of a plurality of reference users with the usage trajectory calculated from the operation history information of a user to be analyzed, and
estimates future usage of the user to be analyzed from the usage trajectory of the reference user that is similar to the usage trajectory of the user to be analyzed.

2. The usage estimation device according to claim 1, comprising:
a reference trajectory generation unit that generates the usage trajectory of each reference user from each piece of operation history information of the plurality of the reference users;
an analysis object trajectory generation unit that generates the usage trajectory from the operation history information of the user to be analyzed;
a similar trajectory detection unit that compares the usage trajectory of the user to be analyzed, which is generated by the analysis object trajectory generation unit, with the usage trajectory of each reference user, which is generated by the reference trajectory generation unit, and detects the usage trajectory of one or more reference users that is similar to the usage trajectory of the user to be analyzed; and
a usage transition destination estimation unit that estimates the future usage of the user to be analyzed from the usage trajectory of the one or more reference users detected by the similar trajectory detection unit.

3. The usage estimation device according to claim 1, comprising:
a reference usage trajectory storage unit that stores the usage trajectory of each reference user generated from each piece of operation history of the plurality of reference users;
an analysis object trajectory generation unit that generates the usage trajectory from the operation history information of the user to be analyzed;
a similar trajectory detection unit that compares the usage trajectory of the user to be analyzed, which is generated by the analysis object trajectory generation unit, with the usage trajectory of each reference user, which is stored to the reference usage trajectory storage unit, and detects the usage trajectory of the one or more reference users that is similar to the usage trajectory of the user to be analyzed; and
a usage transition destination estimation unit that estimates the future usage of the user to be analyzed from the usage trajectory of the one or more reference users detected by the similar trajectory detection unit.

4. The usage estimation device according to claim 2, wherein the usage transition destination estimation unit comprises:
a classification unit that classifies the usage trajectory of the one or more reference users detected by the similar trajectory detection unit into one or more clusters, the cluster being composed of the similar usage trajectories;
a cluster selection unit that selects the cluster that satisfies a predetermined condition from the one or more clusters; and
an estimation unit that estimates the future usage of the user to be analyzed from the usage trajectory of the one or more reference users included in the cluster selected by the cluster selection unit.

5. The usage estimation device according to claim 4, wherein the predetermined condition is a condition to include the usage trajectory of the reference user who masters the terminal device better.

6. The usage estimation device according to claim 5, wherein the cluster selection unit calculates an evaluation value indicating a level of proficiency for each of the plurality clusters based on the operation history information used to generate the usage trajectory belonging to the cluster, and selects the cluster with the largest evaluation value.

7. The usage estimation device according to claim 5, wherein the cluster selection unit calculates an evaluation value indicating a level of satisfaction of the user for each of the plurality clusters based on feedback information from the user that is associated with the operation history information used to generate the usage trajectory belonging to the cluster and stored, and selects the cluster with the largest evaluation value.

8. The usage estimation device according to claim 1, further comprising a recommendation information determination unit that determines recommendation information according to the future usage estimated for the user to be analyzed and outputs the recommendation information.

9. The usage estimation device according to claim 8, wherein the recommendation information is information to recommend all or a part of an application in which usage history is described in the operation history information that is used to generate the usage trajectory of the reference user that is used to estimate the future usage of the user to be analyzed.

10. The usage estimation device according to claim 8, further comprising a recommendation information display unit displays the recommendation information determined by the recommendation information determination unit, the recommendation information display unit being included in the terminal device used by the user to be analyzed.

11. A usage estimation method comprising:
when a trajectory made by dividing operation history information of a user on a terminal device by time, calculating a group of feature amount representing usage for each piece of the operation history information in each division section, and connecting points corresponding to the group of feature amount on a space based on the feature amount is referred to as a usage trajectory,
comparing the usage trajectory of each reference user calculated from the operation history information of a plurality of reference users with the usage trajectory calculated from the operation history information of a user to be analyzed; and
estimating future usage of the user to be analyzed from the usage trajectory of the reference user that is similar to the usage trajectory of the user to be analyzed.

12. The usage estimation method according to claim 11, further comprising:
a) generating the usage trajectory of each reference user from each piece of the operation history information of the plurality of reference users, by using a reference trajectory generation means;
b) generating the usage trajectory from the operation history information of the user to be analyzed, by using an analysis object trajectory generation means;
c) comparing the usage trajectory of the user to be analyzed, which is generated by the analysis object trajectory generation means, with the usage trajectory of each reference user, which is generated by the reference trajectory generation means, and detecting the usage trajectory of one or more reference users that is similar to the usage trajectory of the user to be analyzed, by using a similar trajectory detection means; and
d) estimating the future usage of the user to be analyzed from the usage trajectory of the one or more reference users detected by the similar trajectory detection means, by using a usage transition destination estimation means.

13. The usage estimation method according to claim 11, further comprising:
b) generating the usage trajectory from the operation history information of the user to be analyzed, by using an analysis object trajectory generation means;
c) comparing the usage trajectory of the user to be analyzed, which is generated by the analysis object trajectory generation means, with the usage trajectory of each reference user, which is stored to the reference usage trajectory storage means, and detecting the usage trajectory of the one or more reference users that is similar to the usage trajectory of the user to be analyzed, by using a similar trajectory detection means; and
d) estimating the future usage of the user to be analyzed from the usage trajectory of the one or more reference users detected by the similar trajectory detection means, by using a usage transition destination estimation means.

14. The usage estimation method according to claim 12, wherein the estimation of the usage d comprises:
d-1) classifying the usage trajectory of the one or more reference users detected by the similar trajectory detection means into one or more clusters, the cluster being composed of the similar usage trajectories, by using a classification means;
d-2) selecting the cluster that satisfies a predetermined condition from the one or more clusters, by a cluster selection means; and
d-3) estimating the future usage of the user to be analyzed from the usage trajectory of the one or more reference users included in the cluster selected by the cluster selection means.

15. The usage estimation method according to claim 14, wherein the predetermined condition is a condition to include the usage trajectory of the reference user who masters the terminal device better.

16. The usage estimation method according to claim 15, wherein in the selection of the cluster d-2, the cluster selection means calculates an evaluation value indicating a level of proficiency for each of the plurality of clusters based on the operation history information used to generate the usage trajectory belonging to the cluster, and selects the cluster with the largest evaluation value.

17. The usage estimation method according to claim 15, wherein in the selection of the cluster d-2, the cluster selection means calculates a level of satisfaction of the user for each of the plurality of clusters based on feedback information from the user which is associated with the operation history information used to generate the usage trajectory belonging to the cluster and stored, and selects the cluster with the largest evaluation value.

18. The usage estimation method according to one of claims 11, further comprising:
e) determining recommendation information according to the future usage estimated for the user to be analyzed and outputting the recommendation information, by a recommendation information determination means.

19. The usage estimation method according to claim 18, wherein the recommendation information is information to recommend all or a part of an application in which usage history is described in the operation history information that is used to generate the usage trajectory of the reference user that is used to estimate the future usage of the user to be analyzed.

20. The usage estimation method according to claim 18, further comprising:
f) displaying the recommendation information determined by the recommendation information determination means, by using a recommendation information display means, the recommendation information display means being included in the terminal device used by the user to be analyzed.

21. A storage medium storing a program to make a computer function, when a trajectory made by dividing operation history information of a user on a terminal device by time, calculating a group of feature amount representing usage for each piece of the operation history information in each division section, and connecting points corresponding to the group of feature amount on a space based on the feature amount is referred to as a usage trajectory, as a means to
compare the usage trajectory of each reference user calculated from the operation history information of a plurality of reference users with the usage trajectory calculated from the operation history information of a user to be analyzed, and
estimate future usage of the user to be analyzed from the usage trajectory of the reference user that is similar to the usage trajectory of the user to be analyzed.

22. the storage medium storing the program according to claim 21 that makes the computer to function as:
a reference trajectory generation means that generates the usage trajectory of each reference user from each piece of operation history information of the plurality of the reference users;
an analysis object trajectory generation means that generates the usage trajectory from the operation history information of the user to be analyzed;
a similar trajectory detection means that compares the usage trajectory of the user to be analyzed, which is generated by the analysis object trajectory generation means, with the usage trajectory of each reference user, which is generated by the reference trajectory generation means, and detects the usage trajectory of one or more reference users that is similar to the usage trajectory of the user to be analyzed; and
a usage transition destination estimation means that estimates the future usage of the user to be analyzed from the usage trajectory of the one or more reference users detected by the similar trajectory detection means.

23. The storage medium storing the program according to claim 21 that makes the computer to function as:
an analysis object trajectory generation means that generates the usage trajectory from the operation history information of the user to be analyzed;
a similar trajectory detection means that compares the usage trajectory of the user to be analyzed, which is generated by the analysis object trajectory generation means, with the usage trajectory of each reference user, which is stored to the reference usage trajectory storage means, and detects the usage trajectory of the one or more reference users that is similar to the usage trajectory of the user to be analyzed; and
a usage transition destination estimation means that estimates the future usage of the user to be analyzed from the usage trajectory of the one or more reference users detected by the similar trajectory detection means.

24. The storage medium storing the program according to claim 22, wherein the usage transition destination estimation means comprises:
a classification means that classifies the usage trajectory of the one or more reference users detected by the similar trajectory detection means into one or more clusters, the cluster being composed of the similar usage trajectories;
a cluster selection means that selects the cluster that satisfies a predetermined condition from the one or more clusters; and
an estimation means that estimates the future usage of the user to be analyzed from the usage trajectory of the one or more reference users included in the cluster selected by the cluster selection means.

25. The storage medium storing the program according to claim 24, wherein the predetermined condition is a condition to include the usage trajectory of the reference user who masters the terminal device better.

26. The usage estimation device according to claim 25, wherein the cluster selection means calculates an evaluation value indicating a level of proficiency for each of the plurality clusters based on the operation history information used to generate the usage trajectory belonging to the cluster, and selects the cluster with the largest evaluation value.

27. The storage medium storing the program according to claim 25, wherein the cluster selection means calculates an evaluation value indicating a level of satisfaction of the user for each of the plurality clusters based on feedback information from the user which is associated with the operation history information used to generate the usage trajectory belonging to the cluster and stored, and selects the cluster with the largest evaluation value.

28. The storage medium storing the program according to one of claims 21, that further makes the computer to function as a recommendation information determination means that determines recommendation information according to the future usage estimated for the user to be analyzed and outputs the recommendation information.

29. The storage medium storing the program according to claim 28, wherein the recommendation information is information to recommend all or a part of an application in which usage history is described in the operation history information that is used to generate the usage trajectory of the reference user that is used to estimate the future usage of the user to be analyzed.

30. The storage medium storing the program according to claim 28, that further makes the computer to function as a recommendation information display means displays the recommendation information determined by the recommendation information determination means, the recommendation information display means being included in the terminal device used by the user to be analyzed.
